(19) United States
(12) Patent Application Publication
(10) Pub. No.: US 2011/0142345 A1
(43) Pub. Date: Jun. 16, 2011

(54) APPARATUS AND METHOD FOR RECOGNIZING IMAGE

(75) Inventors: Sang Hun Yoon, Daejeon (KR); Ik Jae Chun, Daejeon (KR); Chun Gi Lyuh, Daejeon (KR); Jung Hee Suk, Daejeon (KR); Tae Moon Roh, Daejeon (KR); Jong Kee Kwon, Daejeon (KR); Jong Dae Kim, Daejeon (KR)

(73) Assignee: Electronics and Telecommunications Research Institute, Daejeon (KR)

(21) Appl. No.: 12/783,180

(22) Filed: May 19, 2010

(30) Foreign Application Priority Data
Dec. 14, 2009 (KR) 10-2009-0123943

(51) Int. Cl. G06K 9/46

(52) U.S. Cl. 382/190

(57) ABSTRACT

Provided are an apparatus and method for recognizing an image. In the apparatus and method for recognizing an image, various features can be extracted by a Haar-like filter using 1^{st} to n^{th} order gradients of the x- and y-axis of an input image, and the input image is correctly classified as a true or false image using, in stages, the extracted features of the input image, multiple threshold values for a true image and multiple threshold values for a false image. Accordingly, the apparatus and method achieve a high recognition rate by performing a small amount of computation. Consequently, it is possible to rapidly and correctly recognize an image, enabling real-time image recognition.

### CROSS-REFERENCE TO RELATED APPLICATION

This application claims priority to and the benefit of Korean Patent Application No. 10-2009-0123943, filed Dec. 14, 2009, the disclosure of which is incorporated herein by reference in its entirety.

### BACKGROUND

1. Field of the Invention

The present invention relates to an apparatus and method for recognizing an image, and more particularly, to an apparatus and method for recognizing an image that achieves a high recognition rate by performing a small amount of computation and thus can recognize an image in real time.

2. Discussion of Related Art

Lately, many image recognition apparatuses that recognize a pedestrian or vehicle in an input image have been developed for the safety of pedestrians and drivers.

Most image recognition apparatuses extract features from an input image and then classify the features by training to recognize an object. Many feature extraction methods use a Haar-like filter and histograms of oriented gradients (HoG).

A feature extraction method using the Haar-like filter has a very high processing speed and thus is frequently used in systems requiring real-time recognition.

FIG. 1 illustrates a conventional feature extraction method using the Haar-like filter.

As shown in FIG. 1, the Haar-like filter extracts (a) edge features, (b) line features, and (c) center features from a detection window and outputs difference in brightness between pixels in a black area and white area as a feature.

However, features extracted even from the same image by the Haar-like filter differ according to the brightness of the input image. For this reason, features extracted by the Haar-like filter have a much lower recognition rate than features extracted using HoG.

Meanwhile, extracted features of an input image are used to classify the input image as a true or false image, which will be described in detail below with reference to FIG. 2.

FIG. 2 illustrates a conventional method of classifying an input image as a true or false image.

In an image classification unit 200 in which first to fourth classifiers 210 to 240 are connected in cascade as shown in FIG. 2, when an input image is determined as a true image by the first classifier 210, it is transferred to the second classifier 220. On the other hand, when the input image is determined as a false image, it is not transferred to the second classifier 220. The second, third and fourth classifiers 220, 230 and 240 also continue the same classification process.

However, when the recognition rate of the first classifier 210 is low, the image classification unit 200 may incorrectly classify a true image as a false image, and thus recognition performance deteriorates.

Consequently, a means for improving recognition rate is needed for an image recognition method using an algorithm that requires a small amount of computation like the Haar-like filter.

### SUMMARY OF THE INVENTION

The present invention is directed to an apparatus and method for recognizing an image that achieve a high recognition rate by performing a small amount of computation.

One aspect of the present invention provides an apparatus for recognizing an image including: a feature extractor for inputting the pixel values of an input image, x-axis and y-axis gradients of the input image, and a value obtained using the x-axis and y-axis gradients into a Haar-like filter and extracting features of the input image; and an image classification unit for classifying the input image as a true or false image using, in stages, the features of the input image extracted by the feature extractor, multiple threshold values for a true image, and multiple threshold values for a false image.

The feature extractor may include: a gradient generator for generating the x-axis and y-axis gradients of the input image; an absolute value calculator for calculating absolute values of the x-axis and y-axis gradients and an absolute value of a complex number formed from the x-axis and y-axis gradients; a Haar-like filter unit for inputting the pixel values of the input image, the x-axis and y-axis gradients, the absolute values of the x-axis and y-axis gradients, and the absolute value of the complex number formed from the x-axis and y-axis gradients into the Haar-like filter and extracting the features of the input image; and a normalizer for normalizing brightness of the input image using the x-axis and y-axis gradients.

The image classification unit may include 1^{st} to N^{th} classifiers connected in cascade, and the 1^{st} to N^{th} classifiers may classify the input image as a true image when a sum of weights of the features of the input image is greater than 1^{st} to N^{th} threshold values for a true image, and as a false image when the sum of weights of the features of the input image is less than 1^{st}to N^{th} threshold values for a false image.

Another aspect of the present invention provides a method of recognizing an image including: generating x-axis and y-axis gradients of an input image; calculating absolute values of the x-axis and y-axis gradients and an absolute value of a complex number formed from the x-axis and y-axis gradients; inputting the pixel values of the input image, the x-axis and y-axis gradients, the absolute values of the x-axis and y-axis gradients, and the absolute value of the complex number formed from the x-axis and y-axis gradients into a Haar-like filter and extracting features of the input image; normalizing brightness of the input image using the x-axis and y-axis gradients; and classifying the input image as a true or false image using, in stages, the extracted features of the input image, multiple threshold values for a true image, and multiple threshold values for a false image.

Classifying the input image as a true or false image using, in stages, the extracted features of the input image may include: classifying the input image as a true image when a sum of weights of the extracted features of the input image is greater than 1^{st} to N^{th} threshold values for a true image; and classifying the input image as a false image when the sum of weights of the extracted features of the input image is less than 1^{st} to N^{th} threshold values for a false image.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 illustrates a conventional feature extraction method using a Haar-like filter;

FIG. 2 illustrates a conventional method of classifying an input image as a true or false image;

FIG. 3 is a block diagram of an apparatus for recognizing an image according to an exemplary embodiment of the present invention;

FIG. 4 shows graphs illustrating operation of a normalizer shown in FIG. 3;

FIG. 5 is a flowchart illustrating operation of an image classification unit shown in FIG. 3; and

FIG. 6 is a flowchart illustrating a method of recognizing an image according to an exemplary embodiment of the present invention.

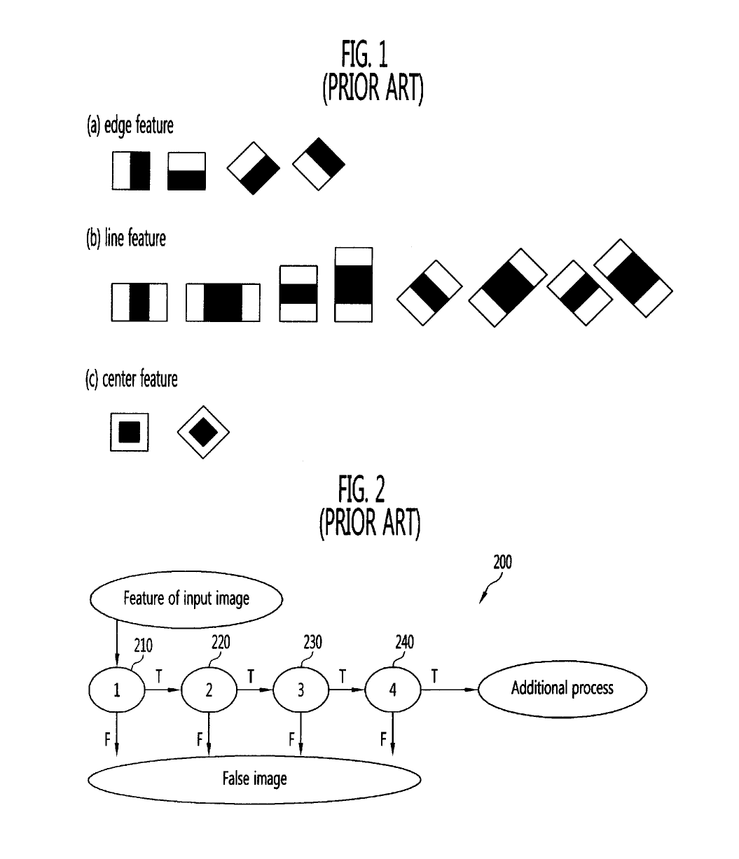

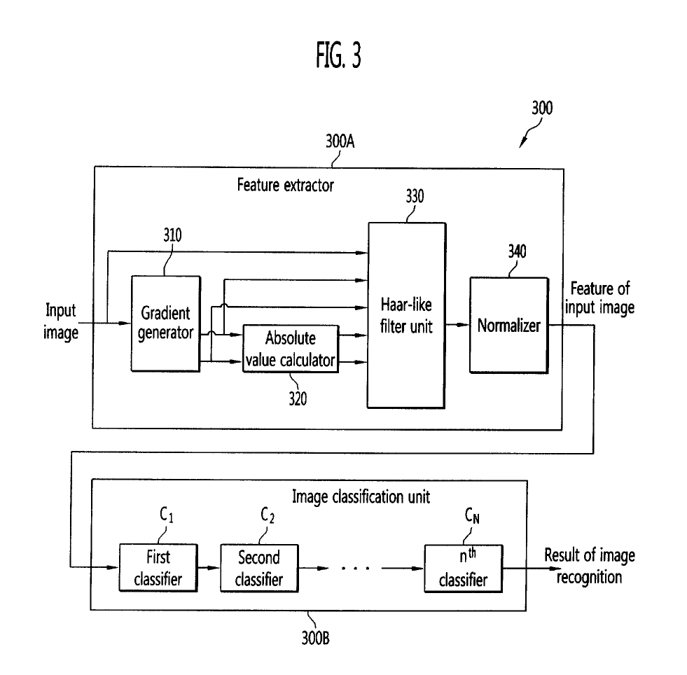

### DETAILED DESCRIPTION OF EXEMPLARY EMBODIMENTS

Hereinafter, exemplary embodiments of the present invention will be described in detail. This invention may, however, be embodied in different forms and should not be construed as limited to the embodiments set forth herein. The following embodiments are described in order to enable those of ordinary skill in the art to embody and practice the present invention. In order to keep the following description of the present invention clear and concise, detailed descriptions of known functions and components may be omitted. When any element of the invention appears in more than one drawing, it is denoted by the same reference numeral in each drawing.

Throughout this specification, when an element is referred to as “comprises,” “includes,” or “has” a component, it should be interpreted as including any stated elements but not necessarily excluding other elements. In addition, the terms “ . . . unit,” “ . . . device,” “ . . . module,” etc. used herein refer to a unit which can be embodied as hardware, software, or a combination thereof, for processing at least one function and performing an operation.

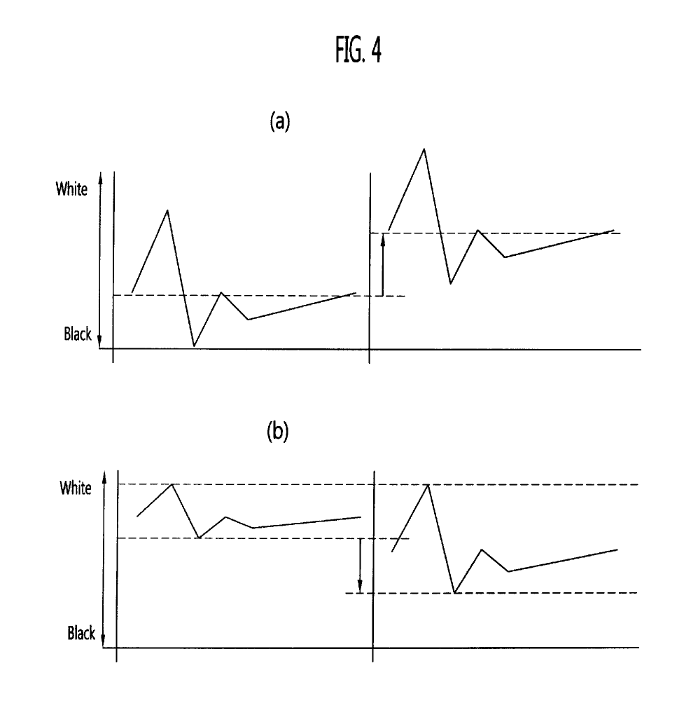

FIG. 3 is a block diagram of an apparatus 300 for recognizing an image according to an exemplary embodiment of the present invention.

Referring FIG. 3, the apparatus 300 for recognizing an image according to an exemplary embodiment of the present invention briefly includes a feature extractor 300A and an image classification unit 300B.

The feature extractor 300A includes a gradient generator 310, an absolute value calculator 320, a Haar-like filter unit 330, and a normalizer 340. And, the image classification unit 300B includes 1^{st} to N^{th} classifiers C₁ to C_{N} connected in cascade.

The gradient generator 310 generates x-axis and y-axis gradients of an input image using a Sobel filter, etc.

Here, the order of the gradient of the x- and the y-axis may be varied from 1 to n.

When a gradient generated by the gradient generator 310 is an n th order gradient, an x-axis n^{th} order gradient F_{n,x}(x, y) and a y-axis n^{th} order gradient F_{n,y}(x, y) can be represented by the following Equation 1:

F_{1,x}(x,y)=s(x−1,y)−s(x+1,y)

F_{1,y}(x,y)=s(x,y−1)−s(x,y+)

F_{n,x}(x,y)=F_{n-1,x}(x−1,y)−F_{n-1,x}(x+1,y)

F_{n,y}(x,y)=F_{n-1,y}(x,y−1)−F_{n-1,y}(x,y+1) [Equation 1]

Here, s(x, y) denotes x-axis and y-axis coordinate values of an input image, and n denotes an integer of 1 or more.

Equation 1 shows examples of x-axis and y-axis gradients generated using the Sobel filter, and x-axis and y-axis gradients generated using another method may be represented in another way.

The absolute value calculator 320 calculates and outputs the absolute values of the x-axis gradient F_{n,x}(x, y) and the y-axis gradient F_{n,y}(x, y) generated by the gradient generator 310, and the absolute value of a complex number formed from the x-axis gradient F_{n,x}(x, y) and the y-axis gradient F_{n,y}(x, y).

The absolute values calculated by the absolute value calculator 320 can be represented by the following Equation 2:

|F_{n,x}(x,y)|

|F_{n,y}(x,y)|

|F_{n,x}(x,y)+j*F_{n,y}(x,y)| [Equation 2]

The Haar-like filter unit 330 inputs the x-axis and y-axis coordinate values s(x, y) of the input image, the x-axis gradient F_{n,x}(x, y) and the y-axis gradient F_{n,y}(x, y) generated by the gradient generator 310, and the absolute values |F_{n,x}(x, y)|, |F_{n,y}(x, y)| and |F_{n,x}(x, y)+j*F_{n,y}(x, y)| calculated by the absolute value calculator 320 into a Haar-like filter, and outputs the result as a feature.

The Haar-like filter used in this exemplary embodiment of the present invention calculates a feature value by subtracting a black area from a white background. The white area has a coefficient of 1, and the black area has a coefficient of −1.

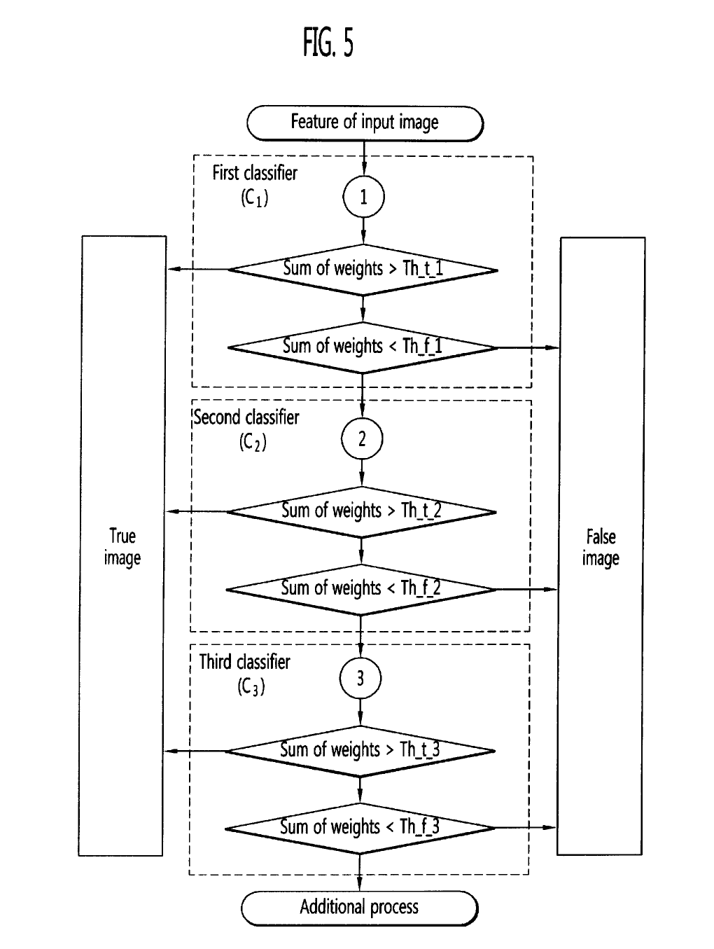

The normalizer 340 normalizes brightness of the input image using the x-axis and y-axis gradients of the input image generated by the gradient generator 310, which will be described in detail below with reference to FIG. 4.

FIG. 4 shows graphs illustrating operation of the normalizer 340 shown in FIG. 3.

Referring to FIG. 4(A), when changes in brightness of an overall input image are similar to each other but the degrees of brightness are different from each other, the normalizer 340 normalizes brightness of the input image using x-axis and y-axis gradients of the input image. Referring to FIG. 4(B), when the degrees of brightness of the input image are similar to each other but changes in brightness are small or large, the normalizer 340 calculates the average of the x-axis and y-axis gradients of the input image and normalizes brightness of the input image using the average.

In other words, the feature extractor 300A according to an exemplary embodiment of the present invention causes such a large amount of information to be input into the Haar-like filter that the Haar-like filter can extract various features.

Thus, the apparatus 300 for recognizing an image according to an exemplary embodiment of the present invention can extract various features by performing a small amount of computation. Consequently, it is possible to rapidly and correctly recognize an object, enabling real-time image recognition.

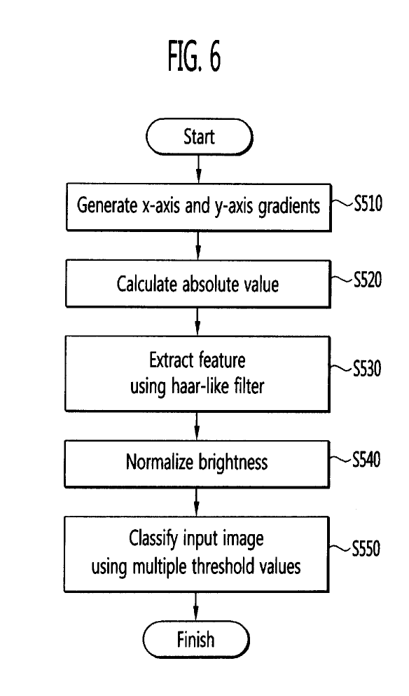

Meanwhile, the image classification unit 300B classifies the input image as a true or false image using, in stages, the features extracted by the feature extractor 300A and multiple threshold values for true and false images, which will be described in detail below with reference to FIG. 5.

FIG. 5 is a flowchart illustrating operation of the image classification unit 300B shown in FIG. 3.

Referring to FIG. 5, the first classifier C₁ included in the image classification unit 300B checks whether the sum of weights of the extracted features is greater than a first threshold value Th_t_{—}1 for a true image.

When the sum of weights of the extracted features is greater than the first threshold value Th_t_{—}1 for a true image, the first classifier C₁ classifies the input image as a true image. Otherwise, the first classifier C₁ checks whether the sum of weights of the extracted features is less than a first threshold value Th_f_{—}1 for a false image.

When the sum of weights of the extracted features is less than the first threshold value Th_f_{—}1 for a false image, the first classifier C₁ classifies the input image as a false image.

Subsequently, the second classifier C₂ included in the image classification unit 300B checks whether the sum of weights of the extracted features is greater than a second threshold value Th_t_{—}2 for a true image.

When the sum of weights of the extracted features is greater than the second threshold value Th_t_{—}2 for a true image, the second classifier C₂ classifies the input image as a true image. Otherwise, the second classifier C₂ checks whether the sum of weights of the extracted features is less than a second threshold value Th_f_{—}1 for a false image.

When the sum of weights of the extracted features is less than the second threshold value Th_f_{—}2 for a false image, the second classifier C₂ classifies the input image as a false image.

Such a classification process continues until the input image is classified as a true or false image.

In other words, the image classification unit 300B according to an exemplary embodiment of the present invention checks whether the sum of weights of the features of the input image is greater than 1^{st} to N^{th} threshold values for a true image and less than 1^{st} to N^{th} threshold values for a false image according to stages until the input image is classified as a true or false image.

Thus, the apparatus 300 for recognizing an image according to an exemplary embodiment of the present invention has recognition performance much superior to a conventional apparatus for recognizing an image that classifies an input image as a true or false image using a threshold value of only one of true and false images.

A method of recognizing an image according to an exemplary embodiment of the present invention will be described below with reference to FIG. 6.

FIG. 6 is a flowchart illustrating a method of recognizing an image according to an exemplary embodiment of the present invention.

When an image is input, x-axis and y-axis gradients of the input image are generated using a Sobel filter, etc (S510).

Here, the order of the gradient of the x- and the y-axis may be varied from 1 to n.

Subsequently, the absolute value of the x-axis gradient, the absolute value of the y-axis gradient, and the absolute value of a complex number formed from the x-axis gradient and the y-axis gradient are calculated (S520).

Subsequently, x-axis and y-axis coordinate values s(x, y) of the input image, the x-axis gradient, the y-axis gradient, and the absolute value of the x-axis gradient, the absolute value of the y-axis gradient, and the absolute value of a complex number formed from the x-axis gradient and the y-axis gradient are input into a Haar-like filter to extract features (S530).

Subsequently, brightness of the input image is normalized using the x-axis and y-axis gradients (S540).

Since the method of normalizing brightness of an input image has been described in detail with reference to FIG. 4, the detailed description will not be reiterated.

Finally, the input image is classified as a true or false image using, in stages, the extracted features of the input image, multiple threshold values for a true image and multiple threshold values for a false image (S550).

Since the method of classifying an input image has been described in detail with reference to FIG. 5, the detailed description will not be reiterated.

In brief, in the method of recognizing an image according to an exemplary embodiment of the present invention, various features are extracted by the Haar-like filter using the 1^{st} to n^{th} order gradients of the x- and y-axis of an input image, and the input image is correctly classified as a true or false image using, in stages, the extracted features of the input image, multiple threshold values for a true image and multiple threshold values for a false image. Thus, it is possible to rapidly and correctly recognize an image.

In an exemplary embodiment of the present invention, various features can be extracted by the Haar-like filter using x-axis and y-axis multiple order gradients of an input image, and the input image can be correctly classified as a true or false image using, in stages, the extracted features of the input image, multiple threshold values for a true image, and multiple threshold values for a false image.

Thus, recognition rate increases while the amount of computation is reduced, so that an object can be rapidly and correctly recognized. Consequently, real-time image recognition is enabled.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An apparatus for recognizing an image, comprising:
a feature extractor for inputting the pixel values of an input image, x-axis and y-axis gradients of the input image, and a value obtained using the x-axis and y-axis gradients into a Haar-like filter and extracting features of the input image; and
an image classification unit for classifying the input image as a true or false image using, in stages, the features of the input image extracted by the feature extractor, multiple threshold values for a true image, and multiple threshold values for a false image.

2. The apparatus of claim 1, wherein the feature extractor includes:
a gradient generator for generating the x-axis and y-axis gradients of the input image;
an absolute value calculator for calculating absolute values of the x-axis and y-axis gradients and an absolute value of a complex number formed from the x-axis and y-axis gradients;
a Haar-like filter unit for inputting the pixel values of the input image, the x-axis and y-axis gradients, the absolute values of the x-axis and y-axis gradients, and the absolute value of the complex number formed from the x-axis and y-axis gradients into the Haar-like filter and extracting the features of the input image; and
a normalizer for normalizing brightness of the input image using the x-axis and y-axis gradients.

3. The apparatus of claim 2, wherein the x-axis and y-axis gradients are 1^{st} to n^{th} order gradients.

4. The apparatus of claim 3, wherein an x-axis n^{th} order gradient F_{n,x}(x, y) and a y-axis n^{th} order gradient F_{n,y}(x, y) are expressed by the following equations:
F_{n,x}(x,y)=F_{n-1,x}(x−1,y)−F_{n-1,x}(x+1,y)
F_{n,y}(x,y)=F_{n-1,y}(x,y−1)−F_{n-1,y}(x,y+1)
where s(x, y) denotes x-axis and y-axis coordinate values of an input image.

5. The apparatus of claim 4, wherein the absolute value of the complex number formed from the x-axis and y-axis gradients is equal to |F_{n,x}(x, y)+j*F_{n,y}(x, y)|.

6. The apparatus of claim 1, wherein the image classification unit includes 1^{st} to N^{th} classifiers connected in cascade, and
the 1^{st} to N^{th} classifiers classify the input image as a true image when a sum of weights of the features of the input image is greater than 1^{st} to N^{th} threshold values for a true image, and as a false image when the sum of weights of the features of the input image is less than 1^{st} to N^{th} threshold values for a false image.

7. A method of recognizing an image, comprising:
generating x-axis and y-axis gradients of an input image;
calculating absolute values of the x-axis and y-axis gradients and an absolute value of a complex number formed from the x-axis and y-axis gradients;
inputting the pixel values of the input image, the x-axis and y-axis gradients, the absolute values of the x-axis and y-axis gradients, and the absolute value of the complex number formed from the x-axis and y-axis gradients into a Haar-like filter, and extracting features of the input image;
normalizing brightness of the input image using the x-axis and y-axis gradients; and
classifying the input image as a true or false image using, in stages, the extracted features of the input image, multiple threshold values for a true image, and multiple threshold values for a false image.

8. The method of claim 7, wherein generating the x-axis and y-axis gradients includes generating an x-axis n^{th} order gradient and a y-axis n^{th} order gradient of the input image.

9. The method of claim 7, wherein extracting the features of the input image includes extracting, at the Haar-like filter, at least one of an edge feature, a line feature and a center feature and outputting difference in brightness between pixels in black and white areas as a feature.

10. The method of claim 7, wherein classifying the input image as a true or false image includes:
classifying the input image as a true image when a sum of weights of the extracted features of the input image is greater than 1^{st} to N^{th} threshold values for a true image; and
classifying the input image as a false image when the sum of weights of the extracted features of the input image is less than 1^{st} to N^{th} threshold values for a false image.
